(19) United States
(12) Patent Application Publication
(10) Pub. No.: US 2026/0086483 A1
(43) Pub. Date: Mar. 26, 2026

(54) IMAGE FORMING APPARATUS AND IMAGE FORMING SYSTEM

(71) Applicant: CANON KABUSHIKI KAISHA, Tokyo (JP)

(72) Inventors: MASATOSHI YOSHIDA, Shizuoka (JP); TAKASHI KUWATA, Shizuoka (JP); KAZUHIDE OKUNO, Tokyo (JP)

(21) Appl. No.: 19/323,425

(22) Filed: Sep. 9, 2025

(30) Foreign Application Priority Data
Sep. 24, 2024 (JP) 2024-165660

(51) Int. Cl. G03G 15/00; G03G 21/16

(52) U.S. Cl. CPC G03G 15/5079; G03G 15/5016; G03G 15/6529; G03G 15/70; G03G 21/1633

(57) ABSTRACT

To improve maintenance efficiency, an image forming apparatus includes an apparatus main body, a conveyance unit configured to detachably attach to the apparatus main body and to include a rotating member that conveys a sheet, a driving source configured to generate a driving force for driving the rotating member, and a control unit configured to obtain a load of the driving source corresponding to each sheet of a plurality of sheets to be conveyed and control output of a notification unit to issue notification of the information in a case where a conveyed sheet jams in a section where the load of the driving source is less than a predetermined threshold value, when the conveyance unit is not normally attached to the apparatus main body.

### BACKGROUND

### Field of the Technology

The present disclosure relates to an image forming apparatus and an image forming system including the same.

### Description of the Related Art

Conventionally, an image forming apparatus may include an apparatus main body and detachable units that are detachably attachable to the apparatus main body, such as a developing unit, a conveyance belt unit, and a fixing device unit (see Japanese Patent Application Laid-Open No. 2003-208060). In a case where the image forming apparatus cannot communicate with a storage unit provided in a detachable unit, the image forming apparatus executes processing for detecting presence or absence of the detachable unit. In the processing for detecting presence or absence of the detachable unit, the presence or absence of the detachable unit is determined based on a magnitude of load torque of a motor that drives the detachable unit.

In general, in a case where a detachable unit including a conveyance roller is not normally attached to an apparatus main body, a jam occurs in which a sheet gets stuck in a conveyance path. However, a cause of such a jam occurrence is not only that a detachable unit is not normally attached to the apparatus main body, but also that there is a possibility of a fault in the image forming apparatus itself. If a cause of a jam occurrence can be identified, maintenance efficiency of the image forming apparatus can be improved.

### SUMMARY

Accordingly, the present disclosure provides an image forming apparatus with improved maintenance efficiency, and an image forming system including the same.

An aspect of the present disclosure provides an image forming apparatus that includes an apparatus main body, a conveyance unit configured to detachably attach to the apparatus main body and to include a rotating member that conveys a sheet, a driving source configured to generate a driving force for driving the rotating member, and a control unit configured to obtain a load of the driving source corresponding to each sheet of a plurality of sheets to be conveyed and control output of a notification of information in a case where a conveyed sheet jams in a section in which the load of the driving source is less than a predetermined threshold value, when the conveyance unit is not normally attached to the apparatus main body.

Another aspect of the present disclosure provides an image forming apparatus that includes an apparatus main body, a conveyance unit configured to detachably attach to the apparatus main body and to include a rotating member that conveys at least one sheet, a sheet detection unit configured to detect a sheet, and a control unit configured to obtain a time from when each sheet of a plurality of sheets to be conveyed is fed to when each sheet of the plurality of sheets reaches the sheet detection unit, and control output of a notification of information in a case where a conveyed sheet jams in a section in which the time is less than a predetermined threshold value, when the conveyance unit is not normally attached to the apparatus main body.

Yet another aspect of the present disclosure provides an image forming system that includes an image forming apparatus and a server that communicates with the image forming apparatus via a network. The image forming apparatus includes an apparatus main body conveyance unit configured to detachably attach to the apparatus main body and to include a rotating member that conveys a sheet, a driving source configured to generate a driving force for driving the rotating member, and a control unit provided in either one of the image forming apparatus and the server, with the control unit being configured to obtain a load of the driving source corresponding to each sheet of a plurality of sheets to be conveyed to the image forming apparatus, and control output of a notification of the information in a case where a conveyed sheet jams in a section in which the load of the driving source is less than a predetermined threshold value, when the conveyance unit is not normally attached to the apparatus main body.

A further aspect of the present disclosure provides an image forming system that includes an image forming apparatus and a server that communicates with the image forming apparatus via a network, with the image forming apparatus including an apparatus main body, a conveyance unit configured to detachably attach to the apparatus main body and to include a rotating member that conveys at least one sheet, a sheet detection unit configured to detect a sheet, and a control unit provided in either one of the image forming apparatus and the server, with the control unit being configured to obtain a time from when each sheet of a plurality of sheets to be conveyed is fed to when each sheet of the plurality of sheets reaches the sheet detection unit, and control output of notification of information in a case where a conveyed sheet jams in a section in which the time is less than a predetermined threshold value, when the conveyance unit is not normally attached to the apparatus main body.

According to the present disclosure, maintenance efficiency can be improved.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic diagram illustrating an image forming apparatus according to a first embodiment. FIG. 1B is a schematic cross-sectional view of the image forming apparatus with a right door unit open.

FIG. 2A is a left side view illustrating a separating roller unit. FIG. 2B is a front view illustrating the separating roller unit. FIG. 2C is a right side view illustrating the separating roller unit.

FIG. 3A is a front view illustrating a state in which the separating roller unit is attached to a holder locking lever. FIG. 3B is a front view illustrating a state in which the holder locking lever is moved to a separated position. FIG. 3C is a front view illustrating a state in which the separating roller unit is removed from the holder locking lever.

FIG. 4A is a plan view illustrating a state in which the separating roller unit is normally attached to an apparatus main body. FIG. 4B is a plan view illustrating a state in which the separating roller unit is not attached to the apparatus main body. FIG. 4C is a plan view illustrating a state in which the separating roller unit is improperly set to the apparatus main body.

FIG. 5A illustrates two sheets being conveyed toward a separation nip. FIG. 5B illustrates the two sheets reaching the separation nip. FIG. 5C illustrates an uppermost sheet being separated from a lower sheet and conveyed.

FIG. 6 is a block diagram illustrating a control system of an image forming system.

FIG. 7 is a flowchart illustrating processing in jam cause identification control.

FIG. 8 is a graph illustrating an integrated value of a pulse-width modulation (PWM) signal for detecting an occurrence of a mistake in setting of the separating roller unit.

FIG. 9 illustrates a sheet feeding apparatus according to a second embodiment.

FIG. 10 is a graph illustrating a sheet arrival time for detecting an occurrence of a mistake in setting of the separating roller unit.

### DESCRIPTION OF THE EMBODIMENTS

### First Embodiment

### Overall Configuration

In a first embodiment of the present disclosure, an image forming apparatus 100 is an electrophotographic type full-color laser beam printer. An image forming apparatus refers to an apparatus, such as a printer, a copying machine, a facsimile, and a multifunction peripheral, that forms an image on a sheet used as a recording medium based on image information input from an external personal computer (PC) or image information read from a document. In addition to a main body having an image forming function, an image forming apparatus may be connected to accessory devices, such as an optional feeder, an image reading apparatus, and a sheet processing apparatus, and an overall system to which such accessory devices are connected is also a type of the image forming apparatus.

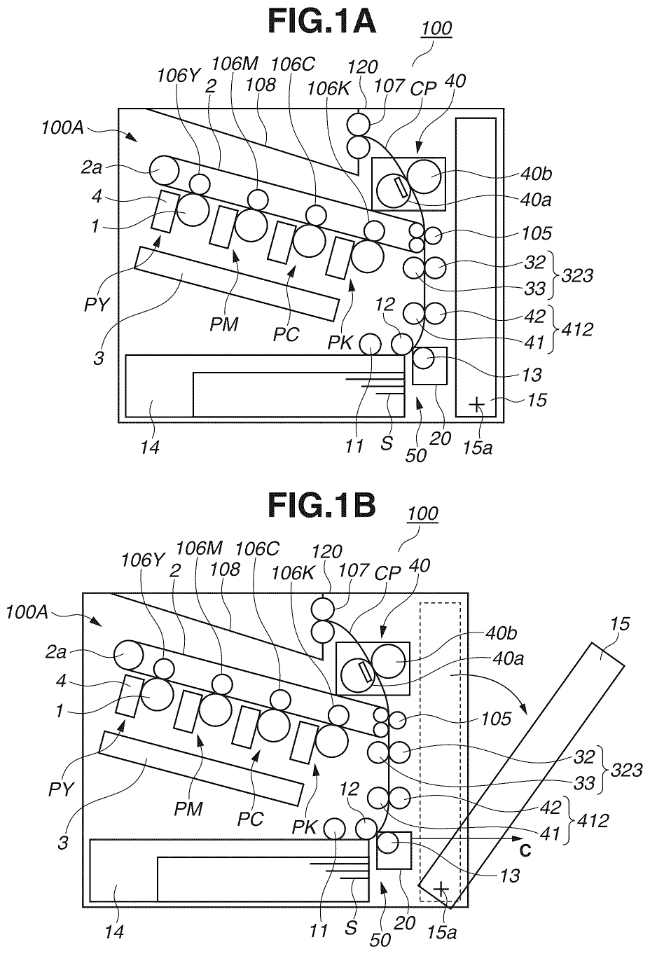

FIG. 1A is a schematic diagram illustrating the image forming apparatus 100. As illustrated in FIG. 1A, the image forming apparatus 100 includes an image forming unit 100A that forms an image on a sheet S, a sheet feeding apparatus 50, and a fixing apparatus 40. The image forming unit 100A is equipped with four process cartridges PY, PM, PC, and PK that respectively form toner images of four colors, yellow (Y), magenta (M), cyan (C), and black (K), and a laser scanner 3.

The four process cartridges PY, PM, PC, and PK have the same configuration except that they form images in different colors. Thus, only a configuration and an image forming process of the process cartridge PY are described, and descriptions of the process cartridges PM, PC, and PK are not repeated.

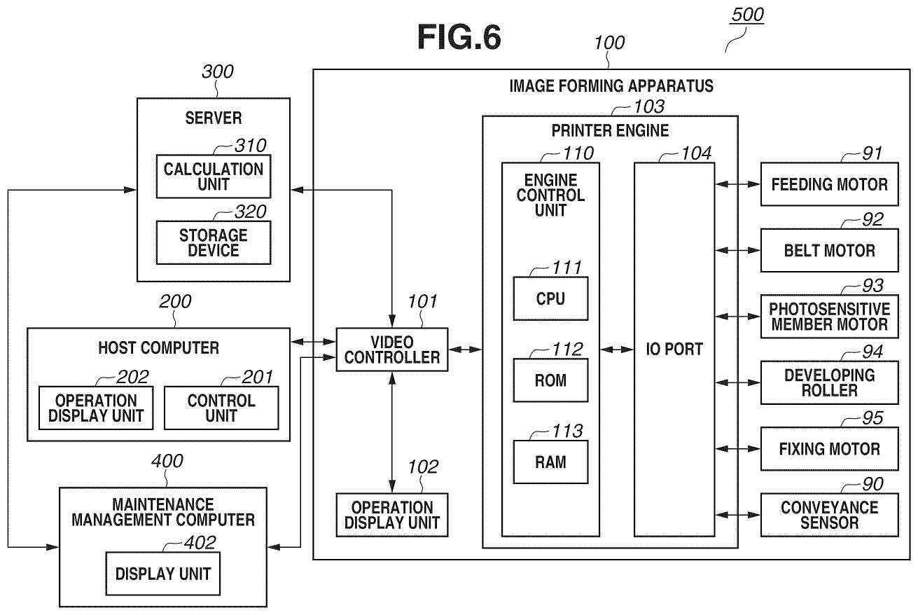

The process cartridge PY includes a photosensitive drum 1, a charging roller, and a developing device 4 that includes a developing roller. The photosensitive drum 1 is formed by coating an organic photoconductive layer on an outer periphery of an aluminum cylinder and is rotated by a photosensitive member motor 93 (FIG. 6). The image forming unit 100A is provided with an intermediate transfer belt 2 wound around a drive roller 2a and the like, and primary transfer rollers 106Y, 106M, 106C, and 106K are provided on the inside of the intermediate transfer belt 2.

The fixing apparatus 40 includes a fixing roller 40a that is heated by a heater, and a pressure roller 40b that is in pressure contact with the fixing roller 40a. The sheet feeding apparatus 50 is provided with a cassette 14 that supports the sheet S, a pickup roller 11 serving as a feeding unit that feeds the sheet S, a conveyance roller 12 and a separating roller 13 that separate the sheets S conveyed by the pickup roller 11 one by one, and the like. The sheet S includes a sheet, paper such as an envelope, a plastic film such as a sheet for overhead projector (OHP), cloth, and the like.

Next, an image forming operation of the image forming apparatus 100 configured as described above is described. In a case where an image signal is input from a host computer 200 (FIG. 6) or the like connected to the image forming apparatus 100 to the laser scanner 3, the laser scanner 3 irradiates the photosensitive drum 1 of the process cartridge PY with a laser beam corresponding to the image signal.

At this time, a surface of the photosensitive drum 1 is uniformly charged to a predetermined polarity and potential by the charging roller in advance, and an electrostatic latent image is formed on the surface by being irradiated with the laser beam from the laser scanner 3. The electrostatic latent image formed on the photosensitive drum 1 is subjected to a development operation executed by the developing device 4, so that a yellow (Y) toner image is formed on the photosensitive drum 1.

Similarly, the laser scanner 3 irradiates the photosensitive drums of the process cartridges PM, PC, and PK with the laser beams, and magenta (M), cyan (C), and black (K) toner images are formed on the respective photosensitive drums. The toner images of the respective colors formed on the respective photosensitive drums are transferred to the intermediate transfer belt 2 by a transfer operation executed by the primary transfer rollers 106Y, 106M, 106C, and 106K. Then, the toner images transferred to the intermediate transfer belt 2 are conveyed to a secondary transfer roller 105 by the intermediate transfer belt 2 being rotated by the drive roller 2a. An image forming process for each color is performed at such a timing that a toner image overlaps an upstream toner image that is primarily transferred to the intermediate transfer belt 2.

In parallel with the image forming process, the sheet S stored in the cassette 14 of the sheet feeding apparatus 50 is sent out by the pickup roller 11. Then, the sheet S is conveyed by the conveyance roller 12, the separating roller 13, and a conveyance roller pair 412 to a registration roller pair 323. The conveyance roller pair 412 includes a drive roller 41 and a driven roller 42 that is rotated following the drive roller 41. The registration roller pair 323 includes a drive roller 32 and a driven roller 33 that is rotated following the drive roller 32.

The sheet S of which skew is corrected by the registration roller pair 323 is conveyed by the registration roller pair 323 at a predetermined conveyance timing. Then, the full-color toner image on the intermediate transfer belt 2 is transferred onto the sheet S with a secondary transfer bias applied to the secondary transfer roller 105.

The sheet S on which the toner image is transferred is applied with a predetermined amount of heat and pressure by the fixing roller 40a and the pressure roller 40b of the fixing apparatus 40, so that the toner is melted and fixed. The sheet S passing through the fixing apparatus 40 is discharged onto a discharge tray 108 by a discharging roller pair 107.

### Separating Roller Unit

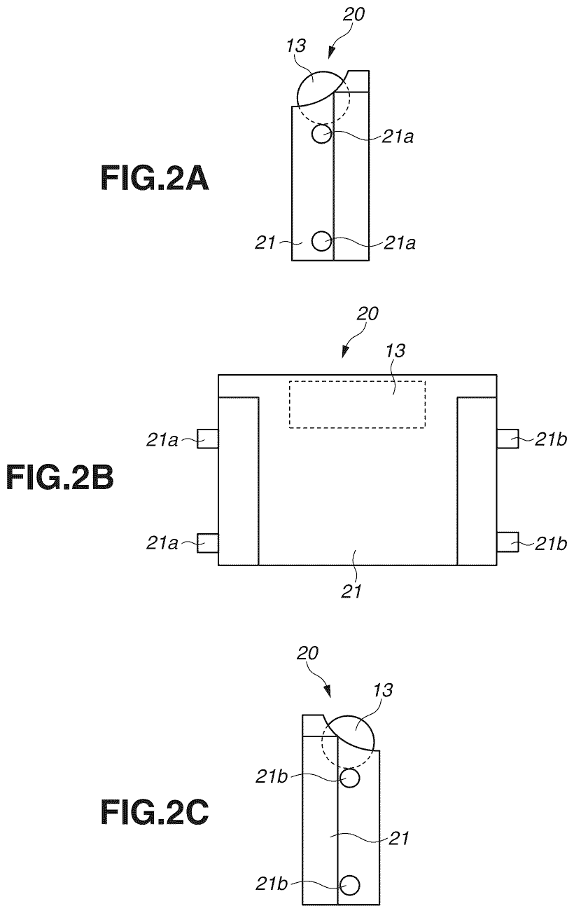

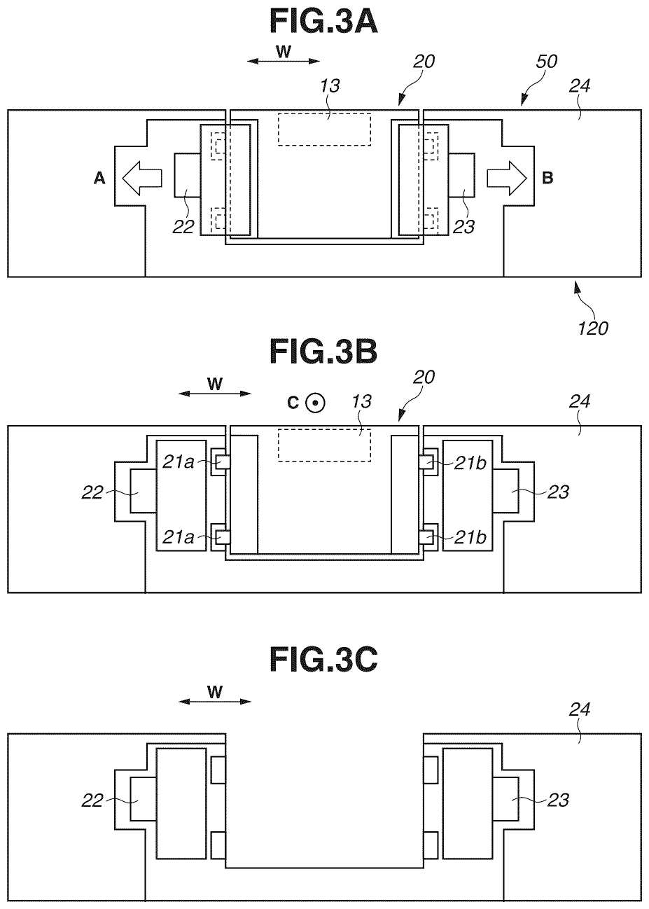

A separating roller unit 20 is described with reference to FIGS. 1B to 4C. FIG. 1B is a schematic cross-sectional view illustrating the image forming apparatus 100 with a right door unit 15 in an open state. FIG. 2A is a left side view illustrating the separating roller unit 20. FIG. 2B is a front view illustrating the separating roller unit 20. FIG. 2C is a right side view illustrating the separating roller unit 20. FIG. 3A is a front view illustrating a state in which the separating roller unit 20 is attached to holder locking levers 22 and 23. FIG. 3B is a front view illustrating a state in which the holder locking levers 22 and 23 are moved to separated positions. FIG. 3C is a front view illustrating a state in which the separating roller unit 20 is removed from the holder locking levers 22 and 23.

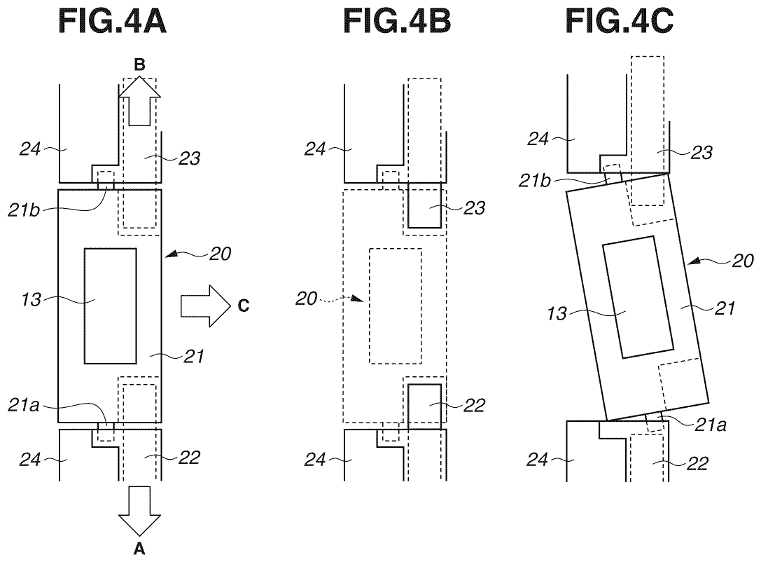

FIG. 4A is a plan view illustrating a state in which the separating roller unit 20 is normally attached to an apparatus main body 120. FIG. 4B is a plan view illustrating a state in which the separating roller unit 20 is not attached to the apparatus main body 120. FIG. 4C is a plan view illustrating a state in which the separating roller unit 20 is improperly set to the apparatus main body 120.

As illustrated in FIG. 1B, the image forming apparatus 100 includes the right door unit 15 that can be opened and closed with respect to the apparatus main body 120 around a rotation shaft 15a and the separating roller unit 20 that includes the separating roller 13. The separating roller unit 20 serving as a conveyance unit is detachably attached to the apparatus main body 120 and can be removed in an arrow C direction with the right door unit 15 open.

As illustrated in FIG. 2A to 2C, the separating roller unit 20 includes a separation holder 21, with the separating roller 13 serving as a rotating member rotatably supported by the separation holder 21.

Two separation holder bosses 21a protrude from one side surface of the separation holder 21 in a sheet width direction W, and two separation holder bosses 21b protrude from the other side surface of the separation holder 21.

As illustrated in FIG. 3A, the sheet feeding apparatus 50 of the image forming apparatus 100 includes a feeding guide 24 fixed to the apparatus main body 120 and the holder locking levers 22 and 23 that are movably supported in the width direction W with respect to the feeding guide 24. The holder locking levers 22 and 23 are configured to be movable between holding positions where they are close to each other in the width direction W and the separated positions where they are separated from each other.

As illustrated in FIG. 3A, each of two the separation holder bosses 21a and 21b are held by the holder locking levers 22 and 23 that are located at the holding positions, so that the separating roller unit 20 is held by the apparatus main body 120. In a case where the separating roller unit 20 is removed from the apparatus main body 120, the holder locking levers 22 and 23 are moved to the separated positions, as illustrated in FIG. 3B. Specifically, the holder locking lever 22 is moved in an arrow A direction illustrated in FIG. 3A, and the holder locking lever 23 is moved in an arrow B direction illustrated in FIG. 3A. The holder locking levers 22 and 23 are respectively urged in directions opposite to the arrow A direction and the arrow B direction by urging members.

The holder locking levers 22 and 23 are located at the separated positions, so that each of the two separation holder bosses 21a and 21b are released from holding by the holder locking levers 22 and 23. As illustrated in FIGS. 1B, 3B, and 3C, the separating roller unit 20 is moved in the arrow C direction in this state, so that the separating roller unit 20 is removed from the apparatus main body 120.

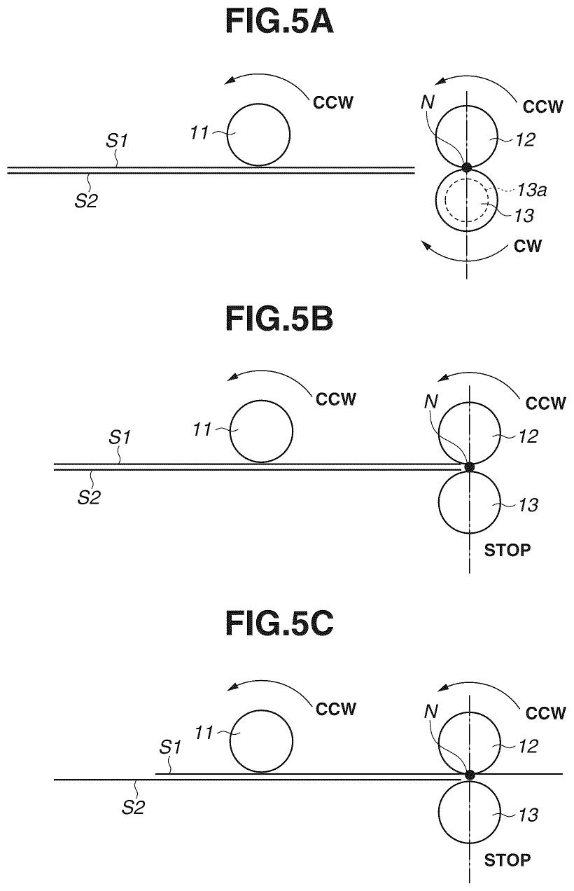

FIG. 4A illustrates a state in which the separating roller unit 20 is normally attached to the apparatus main body 120. At this time, the separation holder bosses 21a, 21a, 21b and 21b are securely held by the holder locking levers 22 and 23, which are located at the holding positions. In a state in which the separating roller unit 20 is normally installed in (attached to) the apparatus main body 120, the separating roller 13 comes into contact with the conveyance roller 12 to form a separation nip N (FIG. 5A) that separates sheets one by one.

As illustrated in FIG. 4B, in a state in which the separating roller unit 20 is not attached to the apparatus main body 120, because the separation holder 21 functions as a part of a sheet conveyance path, a center portion of the conveyance path is missing in the width direction W. Further, because the separating roller 13 included in the separating roller unit 20 is not present, the conveyance roller 12 cannot form the separation nip N with the separating roller 13. Thus, in a state in which the separating roller unit 20 is not attached to the apparatus main body 120, the sheet S fed by the pickup roller 11 is conveyed only by a conveyance force of the pickup roller 11 until it reaches the conveyance roller pair 412. In this case, since the separation nip N is not formed, the sheets conveyed by the pickup roller 11 cannot be separated one by one, and there is a risk of a jam occurrence due to the sheets S being overlappingly fed.

As illustrated in FIG. 4C, a state in which the separating roller unit 20 is attached deviated from a normal position illustrated in FIG. 4A is referred to as a state in which the separating roller unit 20 is attached with a mistake in the setting, also referred to as a mistaken setting state. The mistaken setting state may include a state in which the separating roller unit 20 is not attached. At this time, the separation holder bosses 21a, 21a, 21b and 21b of the separating roller unit 20 are not normally held by the holder locking levers 22 and 23. Accordingly, the separating roller unit 20 is in an inclined state as compared with a state normally attached as illustrated in FIG. 4A.

The mistaken setting state of the separating roller unit 20 is not resolved even if the right door unit 15 is closed. Further, the separation nip N is not normally formed, and the sheet S is conveyed in a state in which misalignment occurs between the conveyance roller 12 and the separating roller 13. This misalignment may cause the sheet to skew, resulting in a jam. Further, the sheets fed by the pickup roller 11 cannot be separated one by one, and there is a risk of a jam occurrence due to the sheets S being overlappingly fed.

### Mechanism for Separating Sheets One by One

A mechanism for separating the sheets S one by one using the separation nip N formed by the conveyance roller 12 and the separating roller 13 is described with reference to FIG. 5A to 5C. FIG. 5A illustrates a state in which two sheets S1 and S2 are conveyed toward the separation nip N. FIG. 5B illustrates a state in which the two sheets S1 and S2 reach the separation nip N. FIG. 5C illustrates a state in which an uppermost sheet S1 is separated from a lower sheet S2 and conveyed.

As illustrated in FIG. 5A, a plurality of sheets are conveyed by the pickup roller 11. In FIG. 5A to 5C, for a sake of description, a case is described in which two sheets, the uppermost sheet S1 and the lower sheet S2, are fed by the pickup roller 11. The separating roller 13 includes a built-in torque limiter 13a that is driven, connected to the separating roller 13. The torque limiter 13a does not necessarily have to be built into the separating roller 13 and may be provided on, for example, a rotation shaft to which the separating roller 13 is fixed.

As illustrated in FIG. 5A, before the sheets S1 and S2 reach the separation nip N, the pickup roller 11 and the conveyance roller 12 rotate in a counterclockwise (CCW) direction, and the separating roller 13 rotates in a clockwise (CW) direction opposite to the CCW direction by being rotated following the conveyance roller 12. At this time, because a friction force in the separation nip N is greater than a limit value of the torque limiter 13a, the torque limiter 13a idly rotates.

As illustrated in FIG. 5B, when the sheets S1 and S2 reach the separation nip N, the uppermost sheet S1 is conveyed by the conveyance roller 12. On the other hand, because a frictional force between the sheets S1 and S2 is less than the limit value of the torque limiter 13a, the sheet S2 is stopped by the separating roller 13, which is in a stopped state. Accordingly, as illustrated in FIG. 5C, only the sheet S1 is conveyed while sliding against the sheet S2, and the plurality of sheets S1 and S2 conveyed to the separation nip N are separated one by one and conveyed.

### Control System

FIG. 6 is a block diagram illustrating a control system of an image forming system 500 according to the present embodiment. As illustrated in FIG. 6, the image forming system 500 serving as a fault diagnosis system includes the image forming apparatus 100, the host computer 200, a server 300, and a maintenance management computer 400. The image forming apparatus 100, the host computer 200, the server 300, and the maintenance management computer 400 are configured to be able to communicate with each other, for example, via a network.

The host computer 200 includes a control unit 201 and an operation display unit 202. The control unit 201 includes a central processing unit (CPU) and performs various types of processing by executing a control program stored in a storage device. The operation display unit 202 includes a display, a keyboard, a mouse, and the like and provides a user interface. For example, the control unit 201 transmits a print job including image data to the image forming apparatus 100 in response to a user operation performed on the operation display unit 202 and causes the image forming apparatus 100 to form an image based on the image data.

The image forming apparatus 100 includes a video controller 101, an operation display unit 102, a printer engine 103, and the like. The video controller 101 of the image forming apparatus 100 performs processing for communicating with the host computer 200, the server 300, and the maintenance management computer 400 that is managed by a dealer. In a case where a print job is received from the host computer 200, the video controller 101 controls image formation based on the print job by the printer engine 103.

The operation display unit 102 includes an operation panel, an operation button, and the like and provides a user interface. The printer engine 103 includes an engine control unit 110 that includes a CPU 111, a read only memory (ROM) 112, and a random access memory (RAM) 113, and an input/output (IO) port 104. The ROM 112 is a nonvolatile memory that retains and stores a control program and various data. A rewritable nonvolatile memory can be used instead of the ROM 112. The RAM 113 is a volatile memory that stores temporary data. The CPU 111 executes a control program stored in the ROM 112 to control each motor (91 to 95), which is described below, via the IO port 104 to form an image on the sheet S.

A feeding motor 91 is a driving source for the pickup roller 11, the conveyance roller 12, the conveyance roller pair 412, and the registration roller pair 323. A belt motor 92 is a driving source for the drive roller 2a that drives the intermediate transfer belt 2. The photosensitive member motor 93 is a driving source for each photosensitive drum 1. A developing motor 94 is a driving source for the developing roller of each developing device 4. A fixing motor 95 is a driving source for the pressure roller 40b of the fixing apparatus 40.

A conveyance sensor 90 is connected to the engine control unit 110 serving as a control unit via the IO port 104. One or a plurality of the conveyance sensors 90 is provided on a conveyance path CP (FIG. 1A) through which a sheet passes in the apparatus main body 120 and can detect the sheet.

The server 300 includes a calculation unit 310 serving as a control unit and a storage device 320.

The calculation unit 310 includes one or more processors (CPUs) and executes a control program stored in the storage device 320 to perform various types of processing. The storage device 320 includes arbitrary volatile and nonvolatile storage devices. The storage device 320 also stores data used by the calculation unit 310 in various types of processing in addition to a program executed by the calculation unit 310. According to the present embodiment, the storage device 320 is a component of the server 300, but a part or all of data described below as being stored in the storage device 320 may be stored in an external device that the server 300 can access via a network.

The maintenance management computer 400 serving as an information processing apparatus includes a display unit 402 that can display information. The maintenance management computer 400 can instruct a user from a remote location how to resolve a fault, supply a regular replacement unit for a worn-out one, and arrange a visit to a user's site to repair a faulty part based on information from the image forming apparatus 100 or the server 300.

### Jam Cause Identification Control

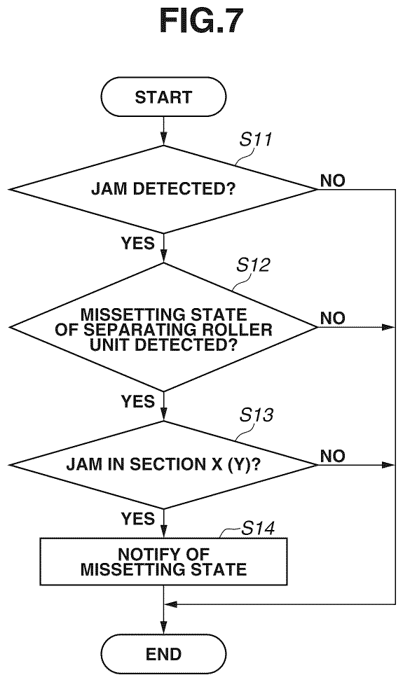

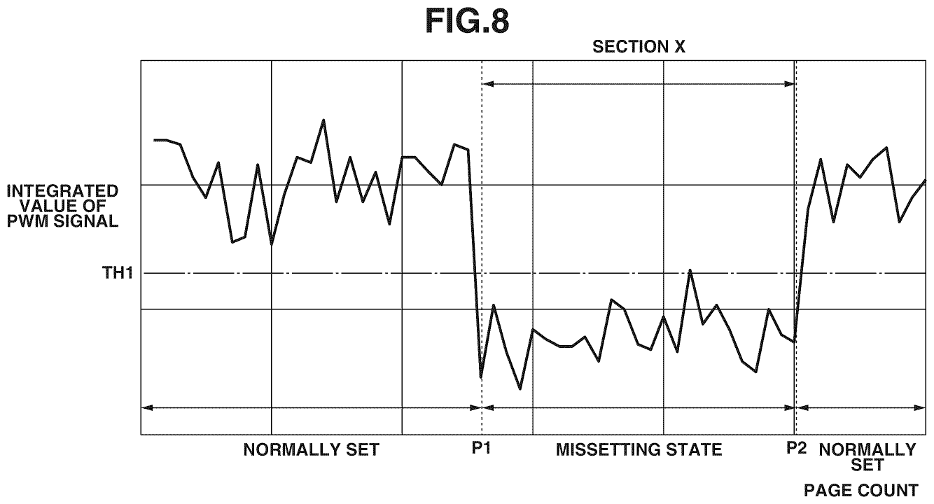

Next, jam cause identification control is described with reference to FIGS. 7 and 8. FIG. 7 is a flowchart illustrating processing in the jam cause identification control. FIG. 8 is a graph illustrating an integrated value of a pulse-width modulation (PWM) signal for detecting an occurrence of a mistaken setting of the separating roller unit 20.

As illustrated in FIG. 7, in step S11, when the jam cause identification control is started, first, the engine control unit 110 of the image forming apparatus 100 determines whether a jam has occurred based on a detection result of the conveyance sensor 90. For example, in a case where a print job is started and a sheet is fed by the pickup roller 11, if the predetermined conveyance sensor 90 does not detect the sheet even after a certain period of time has elapsed, the engine control unit 110 determines that a jam has occurred.

In a case where it is determined that a jam has occurred (YES in step S11), in step S12, the engine control unit 110 determines whether the mistaken setting state of the separating roller unit 20 is detected.

Here, a method for detecting the mistaken setting state of the separating roller unit 20 according to the present embodiment is described with reference to FIG. 8. The separating roller 13 of the separating roller unit 20 is rotated following the conveyance roller 12. According to the present embodiment, the conveyance roller 12 is driven by the feeding motor 91 including a direct current (DC) brushless motor. In other words, the feeding motor 91 serving as a driving source generates a driving force for driving the separating roller 13. The feeding motor 91 is controlled based on a control signal from the engine control unit 110.

More specifically, the engine control unit 110 compares a rotation speed target value of the feeding motor 91 with a rotation speed output from a speed detection unit of the feeding motor 91, and generates and outputs a PWM signal. The PWM signal chops a drive current of the feeding motor 91 to control the rotation speed of the feeding motor 91. In other words, the PWM signal is repeatedly turned on and off at a constant frequency and thus can control a time during which a current flows and adjust an average current supplied to the feeding motor 91. When a duty ratio of the PWM signal (a ratio of “on” in an on-off period) is low, the feeding motor 91 rotates at a low speed, and when the duty ratio of the PWM signal is high, the feeding motor 91 rotates at a high speed. The feeding motor 91 may include another motor such as a stepping motor.

In a case where a load on the feeding motor 91 is large, a difference occurs instantaneously between the rotation speed target value transmitted from the engine control unit 110 and the rotation speed output from the speed detection unit, and the PWM signal is generated to make an actual rotation speed reach the rotation speed target value. In other words, when a case where a conveyance load, namely, the load on the feeding motor 91 is large is compared with a case where the conveyance load is small, an integrated value of the PWM signal is larger in the case where the conveyance load is large.

Thus, there is a correlation between the load on the feeding motor 91 and the integrated value of the PWM signal. In a case where the load on the feeding motor 91 increases, the integrated value of the PWM signal also increases, and in a case where the load on the feeding motor 91 decreases, the integrated value of the PWM signal also decreases.

A horizontal axis in FIG. 8 indicates a page count, that is, a total number of pages printed so far.

A vertical axis in FIG. 8 indicates the integrated value of the PWM signal for controlling the feeding motor 91 from a start of sheet feeding by the pickup roller 11 until a predetermined time (hereinbelow, simply referred to as the integrated value of the PWM signal). The above-described predetermined time may be set to arbitrary time until the next sheet is fed. The integrated value of the PWM signal is indicated for each of a plurality of sheets conveyed and is the integrated value per page. The dash-dotted line in FIG. 8 indicates a threshold value TH1 for determining whether the separating roller unit 20 is in the mistaken setting state.

As can be seen from FIG. 8, from a start of a job to a page count P1, or from a page count P2 and onwards, the integrated value of the PWM signal remains higher than the threshold value TH1. In a case where the separating roller unit 20 is normally attached to (installed in) the apparatus main body 120, a load of the torque limiter 13a built in the separating roller 13 is applied to the feeding motor 91. Thus, the integrated value of the PWM signal increases as the load on the feeding motor 91 increases, and the integrated value of the PWM signal becomes higher than the threshold value TH1.

On the other hand, from the page count P1 to the page count P2, the integrated value of the PWM signal remains lower than the threshold value TH1. In a case where the separating roller unit 20 is in the mistaken setting state, a driving force is not properly transmitted from the conveyance roller 12 to the separating roller 13, and the load of the torque limiter 13a built in the separating roller 13 is not applied to the feeding motor 91. Thus, the integrated value of the PWM signal decreases as the load on the feeding motor 91 decreases, and the integrated value of the PWM signal is reduced below the threshold value TH1.

In this way, it is possible to determine whether the separating roller unit 20 is in a normal set state or in the mistaken setting state from the load on the feeding motor 91, which is a value based on the integrated value of the PWM signal. According to the present embodiment, the engine control unit 110 acquires data of the integrated value of the PWM signal as illustrated in FIG. 8. Then, the engine control unit 110 identifies a section X (Step S13) in which the separating roller unit 20 is determined as being in the mistaken setting state, that is, a section from the page counts P1 to P2 from the data.

The threshold value TH1 is not limited to a fixed value and may be changed according to a print mode. For example, the engine control unit 110 has a plurality of print modes that are changed according to an attribute of a sheet to be conveyed, such as a basis weight and a thickness. In a case where a sheet having a first basis weight, such as thin paper, is conveyed, a first print mode is executed in which the sheet is conveyed at a first speed.

Further, in a case where a sheet having a second basis weight heavier than the first basis weight, such as thick paper, is conveyed, a second print mode is executed in which the sheet is conveyed at a second speed slower than the first speed. At this time, the threshold value TH1 in the first print mode is greater than the threshold value TH1 in the second print mode. In other words, it can be said that the predetermined threshold value TH1 is changed according to the attribute of the sheet to be conveyed.

According to the present embodiment, the mistaken setting state of the separating roller unit 20 can be detected, as described above. Then, returning to the flowchart in FIG. 7, in a case where the mistaken setting state of the separating roller unit 20 is detected (YES in step S12), in step S13, the engine control unit 110 determines whether it is a jam in the section X. In other words, in a case where the sheet jams between the page counts P1 to P2, it is determined that the jam has occurred in the section X.

In a case where it is determined that the jam has occurred in the section X (YES in step S13), in step S14, the engine control unit 110 issues a notification of information in response to the separating roller unit 20 being in the mistaken setting state. The information regarding the separating roller unit 20 being in the mistaken setting state is issued by a message, a sound, an image, or arbitrary combinations of them and is notified to at least one of the operation display units 102 and 202 and the display unit 402, which serve as notification units. The information regarding the separating roller unit 20 being in the mistaken setting state is, for example, a message regarding a method for resolving the mistaken setting state.

In a case where a jam is not detected in step S11 (NO in step S11), in a case where the mistaken setting state of the separating roller unit 20 is not detected in step S12 (NO in step S12), or in a case where it is not determined that a jam has occurred in the section X in step S13 (NO in step S13), the jam cause identification control is terminated.

The processing in steps S13 and S14 may be performed by the engine control unit 110 of the image forming apparatus 100, or also the control unit 201 of the host computer 200, the calculation unit 310 of the server 300, or the maintenance management computer 400. For example, in a case where the calculation unit 310 of the server 300 determines that a jam has occurred in the section X based on various analyses, the calculation unit 310 may notify the display unit 402 of the maintenance management computer 400 of the information regarding the separating roller unit 20 being in the mistaken setting state. The processing by the server 300 enables more advanced statistical processing.

As described above, according to the present embodiment, the section X in which the separating roller unit 20 is in the mistaken setting state is identified, and thus it is possible to identify a cause of a jam in a case where the jam occurs. For example, in a case where it is determined that a jam has occurred in the section X, a user can be notified of appropriate troubleshooting for the mistaken setting state. Conversely, in a case where it is determined that the jam has occurred in a section other than the section X, it is determined as a fault in the image forming apparatus 100 itself, and the user can be so notified. Accordingly, maintenance efficiency of the image forming apparatus 100 can be improved.

Savings are also realized because the dealer in charge of maintenance management using the maintenance management computer 400 need be dispatched for a service to identify the cause of the jam. Then, the dealer in charge of maintenance management can, for example, supply the separating roller unit 20 and remotely instruct how to replace the separating roller unit 20 via a telephone or the like, thereby resolving the problem. In this way, by comprehending that the cause of the jam is the mistaken setting of the separating roller unit 20, unnecessary dispatch of the dealer for a service can be suppressed and a service cost can be reduced.

In the market for image forming apparatuses typified by laser printers, there has been an increase in opportunities for dealers to enter into maintenance contracts or pay-as-you-go contracts (for example, contracts in which fees are charged depending on the number of pages printed) with users. Under these contract types, service costs are included in the print unit price, so that it is important to reduce unnecessary dispatch to user's sites and to improve efficiency of troubleshooting.

In a case where the image forming apparatus 100 includes a plurality of stages of the cassettes 14, accuracy of cause identification can be improved by adding to a condition for cause identification a relationship between a location where the mistaken setting of the separating roller unit 20 occurred and the cassette 14 that fed the sheet at the time of the jam occurrence. Specifically, in a case where a jam has occurred, it is determined that there is a high possibility that the jam has occurred due to the mistaken setting of the separating roller unit 20 only in a case where the integrated value of the PWM signal of the feeding motor 91 corresponding to the cassette 14 that fed the jammed sheet is the threshold value TH1 or less. Accordingly, the accuracy of jam cause identification can be improved.

Further, the mistaken setting of the separating roller unit 20 may be identified from an average change amount of the integrated value of the PWM signal before and after the page count at which the right door unit 15 is opened and closed. In the configuration according to the present embodiment, a user cannot replace the separating roller unit 20 unless the right door unit 15 is opened. In other words, unless the right door unit 15 is opened, the mistaken setting of the separating roller unit 20 does not occur, and thus the cause can be identified in this manner. In this case, it is possible to more accurately identify the mistaken setting of the separating roller unit 20 than a case where the page count before and after the right door unit 15 is opened and closed is not used.

### Second Embodiment

A second embodiment of the present disclosure is described, in which a mistaken setting state of a separating roller unit 20 can be detected using a detection method different from that according to the first embodiment. Thus, configurations similar to those according to the first embodiment are not repeated in the drawings and the description referring to the same reference numerals is incorporated by reference.

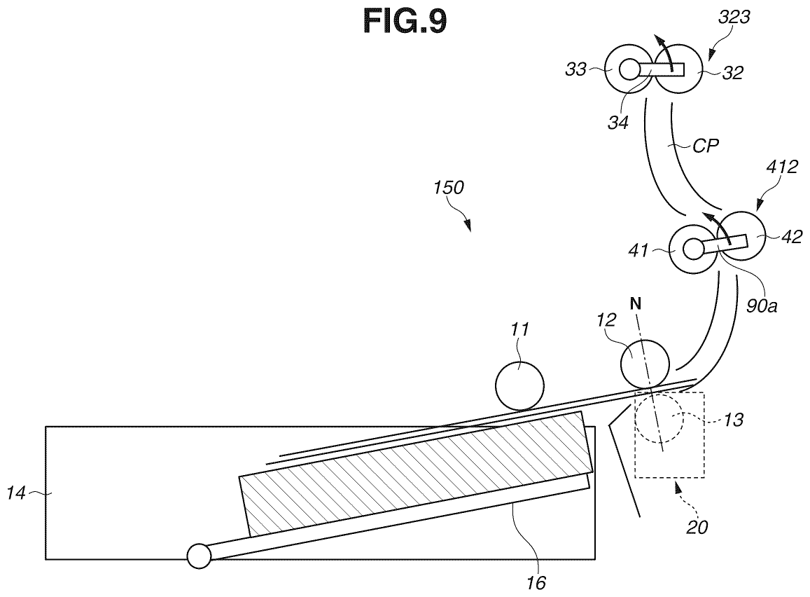

FIG. 9 illustrates a sheet feeding apparatus 150 according to the second embodiment. In FIG. 9, the separating roller unit 20 is removed from the apparatus main body 120 (FIG. 1A). As illustrated in FIG. 9, the sheet feeding apparatus 150 includes a conveyance sensor 90a and a registration sensor 34, which serve as sheet detection units. The conveyance sensor 90a is provided near the conveyance roller pair 412 and includes a rotation unit that rotates by being pressed against a sheet and a sensor unit that switches on and off as the rotation unit rotates. Similarly, the registration sensor 34 is provided near the conveyance roller pair 412 and includes a rotation unit that rotates by being pressed against a sheet and a sensor unit that switches on and off as the rotation unit rotates. These sensor units are composed of, for example, optical sensors. The conveyance sensor 90a and the registration sensor 34 can detect a sheet conveyed in the conveyance path CP.

A sheet fed from the cassette 14 by the pickup roller 11 passes through the conveyance path CP and is detected by the conveyance sensor 90a. Then, the sheet comes into contact with a shutter member provided immediately before a nip between the registration roller pair 323, and thus skew of the sheet is corrected. After passing through the shutter member, the sheet is detected by the registration sensor 34, and the image forming unit 100A (FIG. 1A) forms an image on the sheet.

As described in the first embodiment, in a state in which the separating roller unit 20 is removed, the separation nip N is not formed, and the sheets are not separated one by one. Thus, the below sheet conveyed together with the uppermost sheet fed by the pickup roller 11 is conveyed downstream in a sheet conveyance direction from a position of the separation nip N. FIG. 9 illustrates such a state.

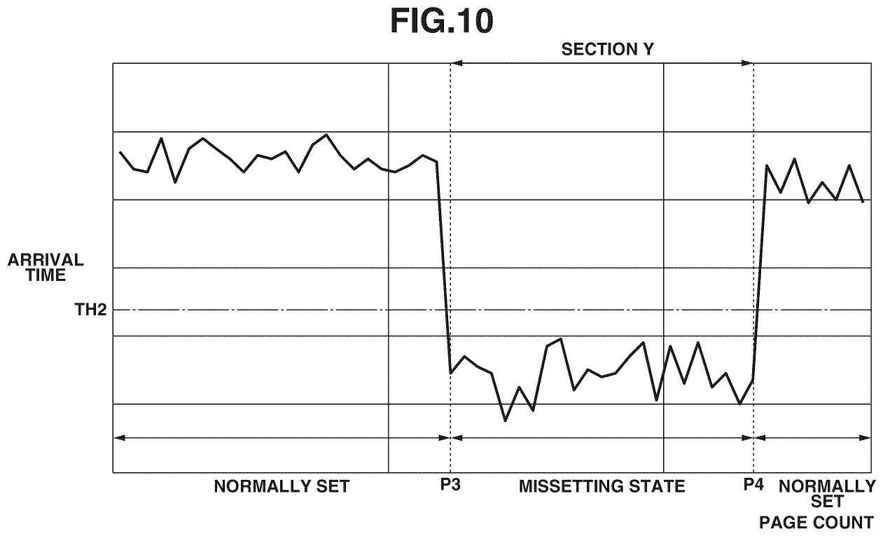

Here, a method for detecting the mistaken setting state of the separating roller unit 20 according to the present embodiment is described with reference to FIG. 10. FIG. 10 is a graph illustrating a sheet arrival time for detecting a mistaken setting of the separating roller unit 20. A horizontal axis in FIG. 10 indicates a page count, that is, a total number of pages printed so far. A vertical axis in FIG. 10 indicates a time from when the pickup roller 11 starts feeding the sheet to when the sheet reaches the conveyance sensor 90a (hereinbelow, simply referred to as an arrival time). The arrival time is indicated for each of a plurality of sheets conveyed. Further, a dash-dotted line in FIG. 10 indicates a threshold value TH2 for determining whether the separating roller unit 20 is in the mistaken setting state.

As can be seen from FIG. 10, from a start of a job to a page count P3, or a page count P4 and onwards, the arrival time remains higher than the threshold value TH2. In a case where the separating roller unit 20 is normally attached to the apparatus main body 120, the separation nip N is formed, so that the sheet conveyed together with the uppermost sheet by the pickup roller 11 is stopped at the separation nip N. In this case, the sheet is not fed from a downstream position of the separation nip N in the sheet conveyance direction. At this time, the arrival time is higher than the threshold value TH2.

On the other hand, from the page count P3 to the page count P4, the arrival time remains lower than the threshold value TH2. In a case where the separating roller unit 20 is in the mistaken setting state (including a state where the separating roller unit is not attached, or a state where the separating roller unit is misaligned), the separation nip N is not formed. Thus, the succeeding sheet, which is conveyed together with the sheet fed by the pickup roller 11, often stops in a state where it advances downstream from the position of the separation nip N in the sheet conveyance direction. In a case where this sheet is fed by the pickup roller 11, the arrival time becomes less than that in a state where the separating roller unit 20 is normally attached. Thus, the arrival time is lower than the threshold value TH2.

In this way, it is possible to determine whether the separating roller unit 20 is in the normal set state or in the mistaken setting state from the above-described arrival time. According to the present embodiment, the engine control unit 110 identifies a section Y in which it is determined that the separating roller unit 20 in the mistaken setting state, that is, a section from the page counts P3 to P4, from the data of the arrival time as indicated in FIG. 10.

The threshold value TH2 is not limited to a fixed value and may be changed according to a print mode. For example, the engine control unit 110 has a plurality of print modes that is changed according to an attribute of a sheet to be conveyed, such as a basis weight and a thickness. In a case where a sheet having the first basis weight, such as thin paper, is conveyed, the first print mode is executed in which the sheet is conveyed at the first speed.

Further, in a case where a sheet having the second basis weight heavier than the first basis weight, such as thick paper, is conveyed, the second print mode is executed in which the sheet is conveyed at the second speed slower than the first speed. At this time, the threshold value TH2 in the first print mode is less than the threshold value TH2 in the second print mode. In other words, it can be said that the predetermined threshold value TH2 is changed according to the attribute of the sheet to be conveyed.

According to the present embodiment, jam cause identification control is similar to that according to the first embodiment, and only a method for detecting the mistaken setting state of the separating roller unit 20 in step S12 illustrated in FIG. 7 is different from the first embodiment. Thus, the present embodiment can achieve the same effects as the first embodiment.

The arrival time according to the present embodiment may be a time from when the pickup roller 11 starts feeding a sheet until when the sheet reaches the registration sensor 34.

According to the present embodiment, the method for detecting the mistaken setting state of the separating roller unit 20 is described, but the method can be applied not only to the separating roller unit 20 but also to another conveyance roller unit. The conveyance roller unit includes the conveyance roller that conveys a sheet passing through the conveyance path CP and is detachably attached to the apparatus main body 120. In a case where the conveyance roller unit is in the mistaken setting state, a time from a certain reference time until a sheet reaches the conveyance sensor 90 is greater than a case where the conveyance roller unit is normally set because a conveyance force is insufficient due to the absence of the conveyance roller unit. Thus, it is possible to identify the section in which the conveyance unit is in the mistaken setting state by calculating the page count of the section exceeding a predetermined threshold value.

### Other Embodiment

Each of the above-described embodiments is described using the electrophotographic type image forming apparatus 100, but the present disclosure is not limited to the electrophotographic type image forming apparatus. For example, the present disclosure can be applied to an inkjet type image forming apparatus that forms an image on a sheet by ejecting ink liquid from a nozzle.

The present disclosure can also be realized by processing of supplying a program for realizing one or more functions of the above-described embodiments to a system or an apparatus via a network or a storage medium and having one or more processors in a computer of the system or the apparatus read and execute the program. Further, the present disclosure can also be realized by a circuit (for example, an application specific integrated circuit (ASIC)) that realizes one or more functions.

### SUMMARY OF PRESENT DISCLOSURE

The present disclosure includes at least following.

### Configuration 1

An image forming apparatus includes:
an apparatus main body;
a conveyance unit configured to detachably attach to the apparatus main body and to include a rotating member that conveys a sheet; and
a driving source configured to generate a driving force for driving the rotating member;
a control unit configured to obtain a load of the driving source corresponding to each sheet of a plurality of sheets to be conveyed and controls output of a notification unit of information in a case where a conveyed sheet jams in a section in which the load of the driving source is less than a predetermined threshold value, when the conveyance unit is not normally attached to the apparatus main body.

### Configuration 2

The image forming apparatus according to the configuration 1 further includes:
a feeding unit configured to feed the sheet; and
a conveyance roller configured to convey the sheet fed by the feeding unit,
wherein the rotating member comes into contact with the conveyance roller in a state in which the conveyance unit is normally attached to the apparatus main body to form a separation nip for separating sheets one by one together with the conveyance roller.

### Configuration 3

The image forming apparatus according to the configuration 2, wherein the control unit is further configured to control the driving source, and the load of the driving source is a value based on an integrated value of a PWM signal for controlling the driving source from a start of feeding the sheet by the feeding unit until a predetermined time.

### Configuration 4

The image forming apparatus according to the configuration 1 to 3, wherein the conveyance unit includes a torque limiter that is driven connected to the rotating member.

### Configuration 5

The image forming apparatus according to any one of the configurations 1 to 4, wherein in a case where the conveyance unit is normally attached to the apparatus main body, the load of the driving source is greater than the predetermined threshold value.

### Configuration 6

The image forming apparatus according to any one of the configurations 1 to 5, wherein the control unit is further configured to control a plurality of printing modes, and wherein the predetermined threshold value is changed according to a respective mode of the plurality of printing modes.

### Configuration 7

The image forming apparatus according to any one of the configurations 1 to 5, wherein the predetermined threshold value is changed according to an attribute of a sheet to be conveyed.

### Configuration 8

An image forming apparatus includes:
an apparatus main body;
a conveyance unit configured to detachably attach to the apparatus main body and to include a rotating member that conveys at least one sheet;
a sheet detection unit configured to detect a sheet; and
a control unit configured to:
obtain a time from when each sheet of a plurality of sheets to be conveyed is fed to when each sheet of the plurality of sheets reaches the sheet detection unit and control output of notification of information in a case where a conveyed sheet jams in a section in which the time is less than a predetermined threshold value, when the conveyance unit not being normally attached to the apparatus main body.

### Configuration 9

The image forming apparatus according to the configuration 8 further includes:
a feeding unit configured to feed the sheet; and
a conveyance roller configured to convey the sheet fed by the feeding unit,
wherein the rotating member comes into contact with the conveyance roller in a state in which the conveyance unit is normally attached to the apparatus main body to form a separation nip for separating sheets one by one together with the conveyance roller.

### Configuration 10

The image forming apparatus according to the configuration 8 or 9, wherein in a case where the conveyance unit is normally attached to the apparatus main body, the time is greater than the predetermined threshold value.

### Configuration 11

The image forming apparatus according to any one of the configurations 8 to 10, wherein the control unit is further configured to control a plurality of printing modes, and wherein the predetermined threshold value is changed according to a respective mode of the plurality of printing modes.

### Configuration 12

The image forming apparatus according to any one of the configurations 8 to 11, wherein the predetermined threshold value is changed according to an attribute of a sheet to be conveyed.

### Configuration 13

An image forming system includes:
an image forming apparatus; and
a server that communicates with the image forming apparatus via a network,
wherein the image forming apparatus includes:
an apparatus main body;
a conveyance unit configured to detachably attach to the apparatus main body and to include a rotating member that conveys a sheet;
a driving source configured to generate a driving force for driving the rotating member; and
a control unit provided in either one of the image forming apparatus and the server, and
wherein the control unit is configured to obtain a load of the driving source corresponding to each sheet of a plurality of sheets to be conveyed to the image forming apparatus and control output of a signal notification of information in a case where a sheet jams in a section in which the load of the driving source is less than a predetermined threshold value, when the conveyance unit is not normally attached to the apparatus main body.

### Configuration 14

The image forming system according to the configuration 13 further includes at least one display unit and an information processing apparatus that communicates with the server via a network,
wherein the at least one display unit is provided in at least one of the image forming apparatus and the information processing apparatus.

### Configuration 15

The image forming system according to the configuration 13 or 14, wherein the control unit is provided in the server.

### Configuration 16

The image forming system according to any one of the configurations 13 to 15, wherein the image forming apparatus includes a feeding unit configured to feed the sheet and a conveyance roller configured to convey the sheet fed by the feeding unit, and wherein the rotating member comes into contact with the conveyance roller in a state in which the conveyance unit is normally attached to the apparatus main body to form a separation nip for separating sheets one by one together with the conveyance roller.

### Configuration 17

The image forming system according to the configuration 16, wherein the load of the driving source is a value based on an integrated value of a PWM signal for controlling the driving source from a start of feeding the sheet by the feeding unit until a predetermined time.

### Configuration 18

The image forming system according to the configuration 13 to 17, wherein the conveyance unit includes a torque limiter that is drivingly connected to the rotating member.

### Configuration 19

The image forming system according to any one of the configurations 13 to 18, wherein, in a case where the conveyance unit is normally installed in the apparatus main body, the load of the driving source is greater than the predetermined threshold value.

### Configuration 20

An image forming system includes:
an image forming apparatus; and
a server that communicates with the image forming apparatus via a network,
wherein the image forming apparatus includes:
an apparatus main body;
a conveyance unit configured to be detachably attached to the apparatus main body and to include a rotating member that conveys a sheet;
a sheet detection unit configured to detect a sheet; and
a control unit provided in either one of the image forming apparatus and the server, and
wherein the control unit is configured to obtain a time from when each sheet of a plurality of sheets to be conveyed is fed to when each sheet of the plurality of sheets reaches the sheet detection unit and controls output of a notification of information in a case where a conveyed sheet jams in a section in which the time is less than a predetermined threshold value, when the conveyance unit is not normally attached to the apparatus main body.

### Configuration 21

The image forming system according to the configuration 20 further includes at least one display unit and an information processing apparatus that communicates with the server via a network,
wherein the at least one display unit is provided in at least one of the image forming apparatus and the information processing apparatus.

### Configuration 22

The image forming system according to the configuration 20 or 21, wherein the control unit is provided in the server.

### Configuration 23

The image forming system according to any one of the configurations 20 to 22further includes:
a feeding unit configured to feed the sheet; and
a conveyance roller configured to convey the sheet fed by the feeding unit,
wherein the rotating member comes into contact with the conveyance roller in a state in which the conveyance unit is normally attached to the apparatus main body to form a separation nip for separating sheets one by one together with the conveyance roller.

### Configuration 24

The image forming system according to any one of the configurations 20 to 23, wherein, in a case where the conveyance unit is normally attached to the apparatus main body, the time is greater than the predetermined threshold value.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-165660, filed Sep. 24, 2024, which is hereby incorporated by reference herein in its entirety.

What is claimed is:

1. An image forming apparatus comprising:
an apparatus main body;
a conveyance unit configured to detachably attach to the apparatus main body, and to include a rotating member that conveys a sheet;
a driving source configured to generate a driving force for driving the rotating member; and
a control unit configured to:
obtain a load of the driving source corresponding to each sheet of a plurality of sheets to be conveyed, and
control output of a notification of information in a case where a conveyed sheet jams in a section in which the load of the driving source is less than a predetermined threshold value, when the conveyance unit is not normally attached to the apparatus main body.

2. The image forming apparatus according to claim 1, further comprising:
a feeding unit configured to feed the sheet; and
a conveyance roller configured to convey the sheet fed by the feeding unit,
wherein the rotating member comes into contact with the conveyance roller in a state in which the conveyance unit is normally attached to the apparatus main body to form a separation nip for separating sheets one by one together with the conveyance roller.

3. The image forming apparatus according to claim 2, wherein:
the control unit is further configured to control the driving source, and
wherein the load of the driving source is a value based on an integrated value of a pulse-width modulation (PWM) signal for controlling the driving source from a start of feeding the sheet by the feeding unit until a predetermined time.

4. The image forming apparatus according to claim 1, wherein the conveyance unit includes a torque limiter that is driven connected to the rotating member.

5. The image forming apparatus according to claim 1, wherein, in a case where the conveyance unit is normally attached to the apparatus main body, the load of the driving source is greater than the predetermined threshold value.

6. The image forming apparatus according to claim 1,
wherein the control unit is further configured to control a plurality of printing modes, and
wherein the predetermined threshold value is changed according to a respective mode printing mode of the plurality of printing modes.

7. The image forming apparatus according to claim 1, wherein the predetermined threshold value is changed according to an attribute of a sheet to be conveyed.

8. An image forming apparatus comprising:
an apparatus main body;
a conveyance unit configured to detachably attach to the apparatus main body and to include a rotating member that conveys at least one sheet;
a sheet detection unit configured to detect a sheet; and
a control unit configured to:
obtain a time from when each sheet of a plurality of sheets to be conveyed is fed to when each sheet of the plurality of sheets reaches the sheet detection unit, and
control output of a notification of information in a case where a conveyed sheet jams in a section in which the time is less than a predetermined threshold value, when the conveyance unit is not normally attached to the apparatus main body.

9. The image forming apparatus according to claim 8, further comprising:
a feeding unit configured to feed the sheet; and
a conveyance roller configured to convey the sheet fed by the feeding unit,
wherein the rotating member comes into contact with the conveyance roller in a state in which the conveyance unit is normally attached to the apparatus main body to form a separation nip for separating sheets one by one together with the conveyance roller.

10. The image forming apparatus according to claim 8, wherein, in a case where the conveyance unit is normally attached to the apparatus main body, the time is greater than the predetermined threshold value.

11. The image forming apparatus according to claim 8,
wherein the control unit is further configured to control a plurality of printing modes, and
wherein the predetermined threshold value is changed according to a respective mode of the plurality of printing modes.

12. The image forming apparatus according to claim 8, wherein the predetermined threshold value is changed according to an attribute of a sheet to be conveyed.

13. An image forming system comprising:
an image forming apparatus; and
a server that communicates with the image forming apparatus via a network,
wherein the image forming apparatus includes:
an apparatus main body;
a conveyance unit configured to detachably attach to the apparatus main body and to include a rotating member that conveys a sheet;
a driving source configured to generate a driving force for driving the rotating member; and
a control unit provided in either one of the image forming apparatus and the server, and
wherein the control unit is configured to:
obtain a load of the driving source corresponding to each sheet of a plurality of sheets to be conveyed to the image forming apparatus, and
control output of a notification of information in a case where a conveyed sheet jams in a section in which the load of the driving source is less than a predetermined threshold value, when the conveyance unit is not normally attached to the apparatus main body.

14. The image forming system according to claim 13, further comprising:
at least one display unit; and
an information processing apparatus that communicates with the server via a network,
wherein the at least one display unit is provided in at least one of the image forming apparatus and the information processing apparatus.

15. The image forming system according to claim 13, wherein the control unit is provided in the server.

16. The image forming system according to claim 13,
wherein the image forming apparatus includes a feeding unit configured to feed the sheet and a conveyance roller configured to convey the sheet fed by the feeding unit, and
wherein the rotating member comes into contact with the conveyance roller in a state in which the conveyance unit is normally attached to the apparatus main body to form a separation nip for separating sheets one by one together with the conveyance roller.

17. The image forming system according to claim 16, wherein the load of the driving source is a value based on an integrated value of a PWM signal for controlling the driving source from a start of feeding the sheet by the feeding unit until a predetermined time.

18. The image forming system according to claim 13, wherein the conveyance unit includes a torque limiter that is driven connected to the rotating member.

19. The image forming system according to claim 13, wherein, in a case where the conveyance unit is normally attached to the apparatus main body, the load of the driving source is greater than the predetermined threshold value.

20. An image forming system comprising:
an image forming apparatus; and
a server that communicates with the image forming apparatus via a network,
wherein the image forming apparatus includes:
an apparatus main body;
a conveyance unit configured to detachably attach to the apparatus main body and to include a rotating member that conveys at least one sheet;
a sheet detection unit configured to detect a sheet; and
a control unit provided in either one of the image forming apparatus and the server, and wherein the control unit is configured to:
obtain a time from when each sheet of a plurality of sheets to be conveyed is fed to when each sheet of the plurality of sheets reaches the sheet detection unit, and
control output of a notification of information in a case where a conveyed sheet jams in a section in which the time is less than a predetermined threshold value, when the conveyance unit is not normally attached to the apparatus main body.

21. The image forming system according to claim 20, further comprising:
at least one display unit; and
an information processing apparatus that communicates with the server via a network,
wherein the at least one display unit is provided in at least one of the image forming apparatus and the information processing apparatus.

22. The image forming system according to claim 20, wherein the control unit is provided in the server.

23. The image forming system according to claim 20, further comprising:
a feeding unit configured to feed the sheet; and
a conveyance roller configured to convey the sheet fed by the feeding unit,
wherein the rotating member comes into contact with the conveyance roller in a state in which the conveyance unit is normally attached to the apparatus main body to form a separation nip for separating sheets one by one together with the conveyance roller.

24. The image forming system according to claim 20, wherein, in a case where the conveyance unit is normally attached to the apparatus main body, the time is greater than the predetermined threshold value.
